(19) United States
(12) Patent Application Publication
(10) Pub. No.: US 2025/0142610 A1
(43) Pub. Date: May 1, 2025

(54) SYSTEMS AND METHODS TO MAXIMIZE COVERAGE OF PREFERRED FREQUENCY BANDS

(71) Applicant: Verizon Patent and Licensing Inc., Basking Ridge, NJ (US)

(72) Inventors: Asif Dawoodi Gandhi, Edison, NJ (US); Chin Chiu, Allen, TX (US); Sachin Vargantwar, Cumming, GA (US)

(21) Appl. No.: 18/496,487

(22) Filed: Oct. 27, 2023

(51) Int. Cl. H04W 72/541; H04W 72/23

(52) U.S. Cl. CPC H04W 72/541; H04W 72/23

(57) ABSTRACT

Systems and methods provide for dynamic updates of downlink (DL) Reference Signal Received Power (RSRP) thresholds to maximize uplink (UL) coverage on cells with a preferred frequency band. A network device identifies a desired minimum UL signal-to-interference-plus-noise ratio (SINR) value for a source cell; maps the minimum UL SINR value to a corresponding DL RSRP value for the source cell; and determines, based on the DL RSRP value, a loaded DL RSRP value that reflects an estimated interference level for a time period. The network device provides one or more DL RSRP thresholds for implementation in the source cell based on the loaded DL RSRP value.

### BACKGROUND

Next Generation mobile networks are designed to increase data transfer rates, increase spectral efficiency, improve coverage, improve capacity, and reduce latency. Different types of mobile networks (e.g., Fourth Generation (4G), Long-Term Evolution (LTE), Fifth Generation (5G), Sixth Generation (6G), etc.) may use different radio frequency bands with different capabilities. For example, 5G network services may be provided on low-band, mid-band, or high-band frequencies with different service levels, such as different data-transfer speeds. Generally, lower-band frequencies can provide larger wireless coverage areas with lower data-transfer speeds, while higher-band frequencies provide smaller wireless coverage areas with higher data-transfer speeds.

While new networks are being deployed and evolving, user equipment (UE) devices need to be supported in both new and legacy networks. For example, the UE devices may switch between different frequency bands, core networks, and radio access networks (RANs) that support either 4G or 5G standards. Currently, cells for 5G low-band, 5G mid-band, 5G high-band, and 4G service may have cells with different and/or overlapping coverage areas. Quality of experience may vary depending on the frequency band used by the UE device.

### BRIEF DESCRIPTION OF THE DRAWINGS

FIG. 1A is a diagram illustrating concepts described herein;

FIG. 1B is a diagram illustrating a network environment according to an implementation described herein;

FIG. 2 is a block diagram illustrating exemplary network components in a portion of the network environment of FIG. 1;

FIG. 3 is a chart illustrating interference data for Physical Uplink Shared Channels (PUSCH) on two different bands;

FIG. 4 illustrates values for a link budget, which is used to determine the maximum uplink pathloss that can be tolerated, according to an implementation;

FIG. 5 is a flow diagram illustrating an exemplary process for providing dynamic updates of downlink Reference Signal Received Power (RSRP) handover thresholds, according to an implementation described herein;

FIG. 6 is a diagram illustrating exemplary components of a device that may be included in a component described herein; and

FIG. 7 is a flow diagram illustrating an exemplary process for implementing dynamic updates of downlink RSRP handover thresholds, according to an implementation described herein.

### DETAILED DESCRIPTION

The following detailed description refers to the accompanying drawings. The same reference numbers in different drawings identify the same or similar elements. Also, the following detailed description does not limit the invention.

Systems and methods described herein maximize wireless cell coverage to keep UE devices connected on a preferred frequency-band (e.g., a frequency-band that provides higher data-transfer speeds) to the maximum extent possible, while at the same time maintaining a desired uplink (UL) signal quality.

The term “cell” as used herein shall be broadly construed as any signal area associated with an access station or other element of a radio network and may be used interchangeably with the term “sector.” A “source cell” as used herein shall be associated with a serving access station and frequency band to which a user equipment (UE) device is currently attached, while a “target cell” or “neighbor cell” may be associated with one or more base stations or one or more neighboring sectors of the source cell of the serving access station that are within physical proximity or adjacent to the serving cell and/or to the UE device. In this regard, signals from the neighboring cells may be “visible” to the UE device and may potentially cause interference in its operation.

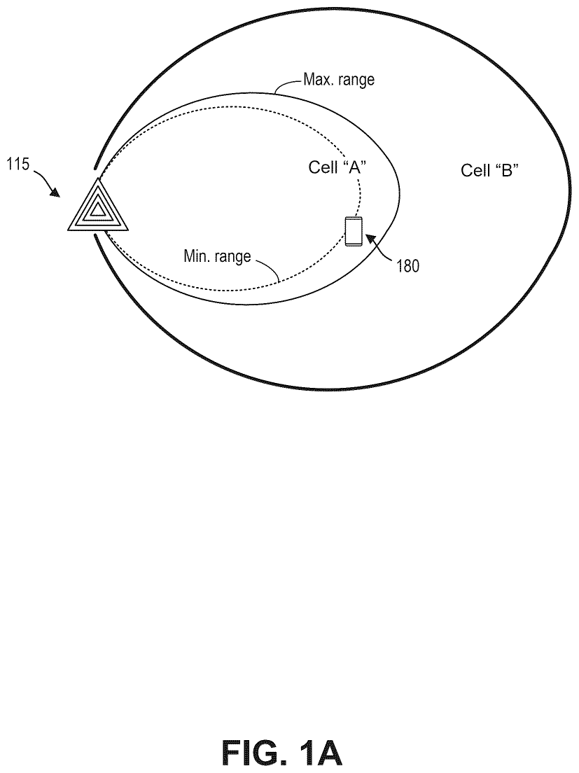

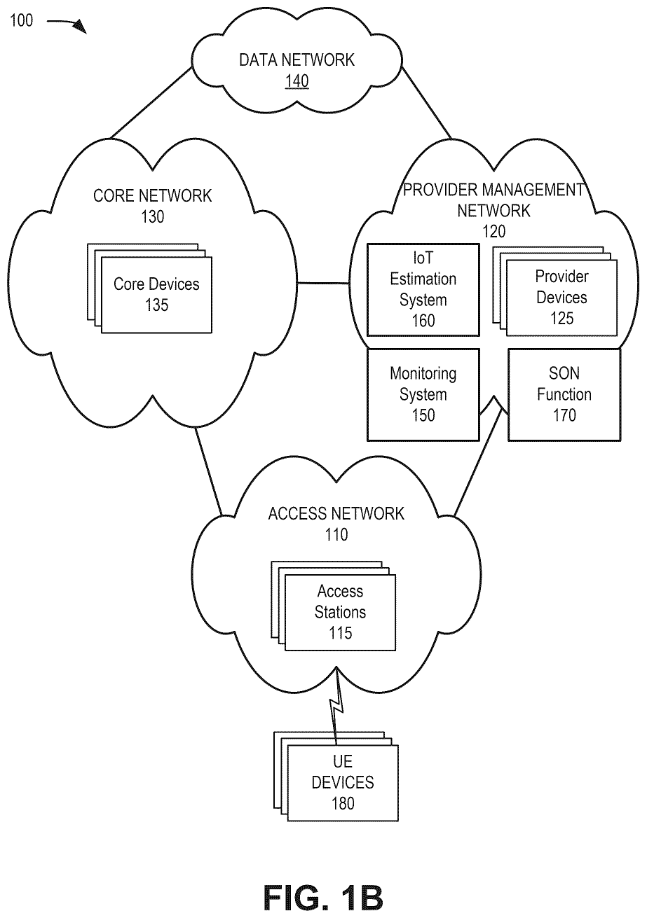

FIG. 1 illustrates concepts described herein. One or more access stations 115 (e.g., a next generation Node B) may provide different areas of wireless network coverage, shown as Cell “A” and Cell “B.” Assume Cell A uses a frequency band that provides a preferred customer experience but has a smaller coverage area than Cell B (e.g., a mid-band, such as 5G NR frequency band n77). Assume Cell B, in comparison with Cell A, uses a frequency band that provides a lesser customer experience but with a larger coverage area (e.g., a low-band, such as 5G NR frequency band n5). As shown in FIG. 1, Cell B may overlap Cell A in whole or in part.

Most of the frequency-bands for 4G and 5G systems (e.g., C-band, millimeter wave, mid-bands, and low-bands) are UL limited. This is because a typical downlink (DL) Effective Isotropic Radiated Power (EIRP) of a transmit antenna in a RAN is higher than the transmit EIRP of a UE device. The UL signal is the limiting factor for when the UE device can effectively communicate with an access station on a given frequency band. For example, the footprint of the UL on some bands can be as much as 4 to 15 dB less than the footprint of the DL. Thus, it is important that appropriate handoff actions are taken based on the UL coverage.

The UE received (Rx) Reference Signal Received Power (RSRP) is a metric that can be used to estimate the limit of UL coverage after adjusting for UL-DL frequency differences (if any) and the different DL transmit (Tx) RSRP values. Different Rx RSRP thresholds (also referred to as SS-RSRP) may be configured to trigger hand-down procedures. These Rx RSRP thresholds may identify, for example, when to start/stop measuring for possible handoff conditions and when to actually initiate an inter-frequency hand-down from a current cell (e.g., Cell A) to a target cell (e.g., Cell B) to maintain a desired UL performance.

In existing systems, the RSRP thresholds for these handoff procedures are statically configured for each cell based on typical conditions and safety factors. These UE Rx RSRP thresholds provide an adequate estimate of UL performance for assumed network conditions (e.g., moderate to high load conditions). However, actual UL performance is dependent on UL Rx signal-to-interference-plus-noise ratio (SINR) at the access station, and not the UL pathloss, or a fixed DL SS-RSRP value. Thus, if actual network loading conditions are different than assumed conditions for a calculated threshold value, the static RSRP thresholds may trigger an inter-frequency hand-down procedure when the existing preferred frequency-band is still able to provide desired UL performance.

According to implementations described herein the UL coverage for cells with preferred frequency bands can be maximized by dynamically adjusting the relevant RSRP thresholds for handoffs based on a computed/estimated Interference over Thermal noise (IoT) level. Thus, the effective range of Cell A may be smaller (e.g., indicated by a “Minimum Range” in FIG. 1A) under certain high loading conditions and larger (e.g., indicated by a “Maximum Range” in FIG. 1A) under certain low loading conditions.

Systems and methods described herein may provide for dynamic updates of DL RSRP thresholds to maximize UL coverage on cells with a preferred frequency band. A network device may identify a desired minimum UL SINR value for a source cell (also referred to as a serving cell); map the minimum UL SINR value to a corresponding DL RSRP value for the source cell; and determine, based on the DL RSRP value, a loaded DL RSRP value that reflects an estimated interference level for a time period. The network device may provide one or more DL RSRP thresholds for implementation in the source cell based on the loaded DL RSRP value.

FIG. 1B is a diagram of an exemplary environment 100 in which systems and/or methods described herein may be implemented. As illustrated, environment 100 includes an access network 110, a provider management network 120, a core network 130, and an external data network 140. Access network 110 includes access stations 115 (also referred to individually or generally as access station 115). Provider management network 120 includes provider devices 125 (also referred to individually or generally as provider device 125). Core network 130 includes core devices 135 (also referred to individually or generally as core device 135). Environment 100 further includes a monitoring system 150, an IoT estimation system 160, a Self-Organizing Network (SON) function 170, and UE devices 180 (also referred to individually or generally as UE device 180).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an application service, as described herein.

The number, the type, and the arrangement of network devices, and the number of UE devices 180, are exemplary. A network device may be implemented according to one or multiple architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge network, fog network, and/or another type of computing architecture, and may be incorporated into various types of network architectures (e.g., software defined network (SDN), virtual network, logical network, network slice, etc.).

Environment 100 includes communication links between the networks, between the network devices, and between UE devices 180 and the network/network devices. Environment 100 may be implemented to include wired, optical, and/or wireless communication links. A connection via a communication link may be direct or indirect. For example, an indirect connection may involve an intermediary device and/or an intermediary network not illustrated in FIG. 1B. A direct communication connection may not involve an intermediary device and/or an intermediary network. The number, type, and arrangement of communication links illustrated in environment 100 are exemplary. Environment 100 may also include various planes of communication including, for example, a control plane, a user plane, a service plane, and/or a network management plane. Environment 100 may include other types of planes of communication.

Access network 110 may include one or multiple networks of one or multiple types and technologies. For example, access network 110 may be implemented to include a 5G-access network (5G-AN) or a 5G-RAN, a future generation RAN (e.g., a 6G RAN or subsequent generation RAN). Access network 110 may also include a legacy RAN (e.g., a Third Generation (3G) RAN, a 4G or 4.5 RAN, etc.). Access network 110 may communicate with and/or include other types of access networks, such as, for example, a WI-FI network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to access network 110, provider management network 120, and/or core network 130.

Depending on the implementation, access network 110 may include one or multiple types of network devices, such as access stations 115. For example, access station 115 may include a gNB, an evolved Node B (eNB), an evolved Long Term Evolution (eLTE) eNB, a remote radio head (RRH), a baseband unit (BBU), a radio unit (RU), a central unit (CU), a CU control plane (CU-CP), a CU user plane (CU-UP), a distributed unit (DU), a small cell node (e.g., a picocell device, a femtocell device, a microcell device, a home eNB, etc.), open network devices (e.g., O-RAN Centralized Unit (O-CU), O-RAN Distributed Unit (O-DU), O-RAN next generation Node B (O-gNB), O-RAN evolved Node B (O-eNB)), 5G ultra-wide band (UWB) nodes, a future generation wireless access station (e.g., a 6G wireless station, etc.), another type of wireless node (e.g., a WI-FI device, a WiMAX device, a hotspot device, etc.) that provides a wireless access service, or another type of network device that provides a transport service (e.g., routing and forwarding service), such as a router, a switch, or another type of layer 3 (e.g., network layer of the Open Systems Interconnection (OSI) model) network device. Additionally, or alternatively, access station 115 may include a wired and/or optical device (e.g., modem, wired access point, optical access point, Ethernet device, etc.) that provides network access.

Provider management network 120 may include one or multiple networks of one or multiple types and technologies. For example, provider management network 120 may be implemented to include a service or an application-layer network, a cloud network, a private network, a public network, a multi-access edge computing (MEC) network, a fog network, the Internet, a service provider network, software defined network (SDN), a virtual network, a packet-switched network, a data center, or other type of network that may provide access to and may host an UE device application, service, or asset (also referred to as an “application service”). In another implementation, all or portions of provider management network 120 may be incorporated within core network 130. According to an exemplary embodiment, provider management network 120 may include monitoring system 150, IoT estimation system 160, and SON function 170, as described further herein.

Depending on the implementation, provider management network 120 may include various network devices such as provider devices 125. For example, provider devices 125 may include servers (e.g., web, application, cloud, etc.), mass storage devices, data center devices, network function virtualization (NFV) devices, devices hosting containers, virtual machines, SDN devices, cloud computing devices, platforms, and other types of network devices, and/or platforms implemented or arranged in accordance with architectures pertaining to various network-related functions (e.g., security, management, charging, billing, authentication, authorization, policy enforcement, development, etc.). In one implementation, provider devices 125 may operate monitoring system 150, IoT estimation system 160, and SON function 170.

Core network 130 may include one or multiple networks of one or multiple network types and technologies. For example, core network 130 may be implemented to include a Next Generation Core (NGC or 5GC) network, an Evolved Packet Core (EPC) of an LTE network, an LTE-Advanced (LTE-A) network, and/or an LTE-A Pro network, a future generation core network (e.g., a 6G or beyond core network, etc.), and/or another type of core network. According to an embodiment, core network 130 may include some or all of monitoring system 150, IoT estimation system 160, or SON function 170, as described herein.

Depending on the implementation, core network 130 may include various types of network devices that are illustrated in FIG. 1B as core devices 135. For example, core devices 135 may include 5G network functions, such a user plane function (UPF), a Non-3GPP Interworking Function (N3IWF), an access and mobility management function (AMF), a session management function (SMF), a unified data management function (UDM), a unified data repository function (UDR), an authentication server function (AUSF), a network data analytics function (NWDAF), an application function (AF), etc. In other implementations, core devices 135 may include 4G network functions, such as a mobility management entity (MME), a home subscriber server (HSS), a service capability exposure function (SCEF), and a packet data network gateway (PGW). Core devices 135 may also include a network device that provides a multi-RAT functionality (e.g., 4G and 5G), such as an SMF with PGW control plane functionality (e.g., SMF/PGW-C), a UPF with PGW user plane functionality (e.g., UPF/PGW-U), a SCEF with a NEF (NEF/SCEF), and/or other combined nodes (e.g., an HSS with a UDM and/or UDR, an MME with an AMF, etc.). According to other exemplary implementations, core devices 135 may include additional, different, and/or fewer network devices than those described.

Data network 140 may include, for example, a packet data network. In an exemplary implementation, UE device 180 may connect to data network 140 via core network 130. Data network 140 may also include and/or be connected to a local area network (LAN), a wide area network (WAN), a metropolitan area network (MAN), an autonomous system (AS) on the Internet, an optical network, a cable television network, a satellite network, a wireless network, an ad hoc network, an intranet, or a combination of networks.

Monitoring system 150 may include devices or software components hosted on network devices or other service components. Monitoring system 150 may monitor and/or collect telemetry information, such as network traffic, latency, jitter, bandwidth, bit error rate, fault counts, and/or other signal quality measurement information. For example, the signal quality measurement information may include a signal-to-interference-plus-noise ratio (SINR) value. In other implementations, the signal quality measurement information may include a reference signal receive power (RSRP) value, a received signal strength indicator (RSSI), a reference signal received quality (RSRQ) value, a signal-to-noise ratio (SNR), a channel quality indicator (CQI), or another type of channel condition value. Furthermore, monitoring system 150 may provide the telemetry information to IoT estimation system 160 and/or SON function 170, periodically (e.g., 5-, 10-, 15-, 60-minute intervals), on demand, or in real time.

IoT estimation system 160 may estimate IoT levels for individual cells based on data received from monitoring system 150. In one implementation, IoT estimation system 160 may compile weighted averages of interference data (e.g., Physical Uplink Shared Channel (PUSCH) data, Physical Uplink Control Channel (PUCCH) data, etc.) and calculate IoT values at periodic intervals. As described further herein, IoT estimation system 160 may identify different day-to-day variation and different patterns for interference in a cell. In one implementation, IoT estimation system 160 may take longer-term averages of IoT, historical information (past weekday and weekend values at the same hours, special events, etc.) into account in calculating/estimating the per-cell IoT values. According to one implementation, IoT estimation system 160 may use machine learning to develop predictive models for IoT levels for different future time periods/intervals.

SON function 170 may monitor wireless network performance (e.g., RAN, core network, and external network telemetry) at various time granularities, and may use predictive ML/AI models, polymorphic algorithms, and other information (e.g., composite neighbor values, underlying candidate target cell information, source cell information, UE device information, application service and/or network slice information, context information (e.g., geographic, day and time information, etc.), and/or other types of information of relevance), as described herein, for orchestration of network resources (e.g., cell, sector, clusters or groups of network devices, etc.) to support maximizing connections for cells on preferred frequency-bands. According to an implementation, SON function 170 may include a network device or NF to generate, and distribute to access stations 115, dynamic updates of DL RSRP handover thresholds, according to implementations described herein.

UE devices 180 include a device that may have computational and/or communication capabilities (e.g., wireless, wired, optical, etc.). UE device 180 may be implemented as a mobile device, a portable device, a stationary device (e.g., a non-mobile device), a device operated by a user, or a device not operated by a user. For example, UE device 180 may be implemented as a smartphone, a mobile phone, a personal digital assistant, a tablet, a netbook, a wearable device (e.g., a watch, glasses, etc.), a computer, a gaming device, a music device, an Internet of Things device, a drone, a smart device, or other type of wireless device (e.g., other type of UE). UE device 180 may be configured to execute various types of software (e.g., applications, programs, etc.). The number and the types of software may vary among UE devices 180. According to implementations described herein, UE device 180 may provide RSRP measurements and other signal strength indicators to access stations 115.

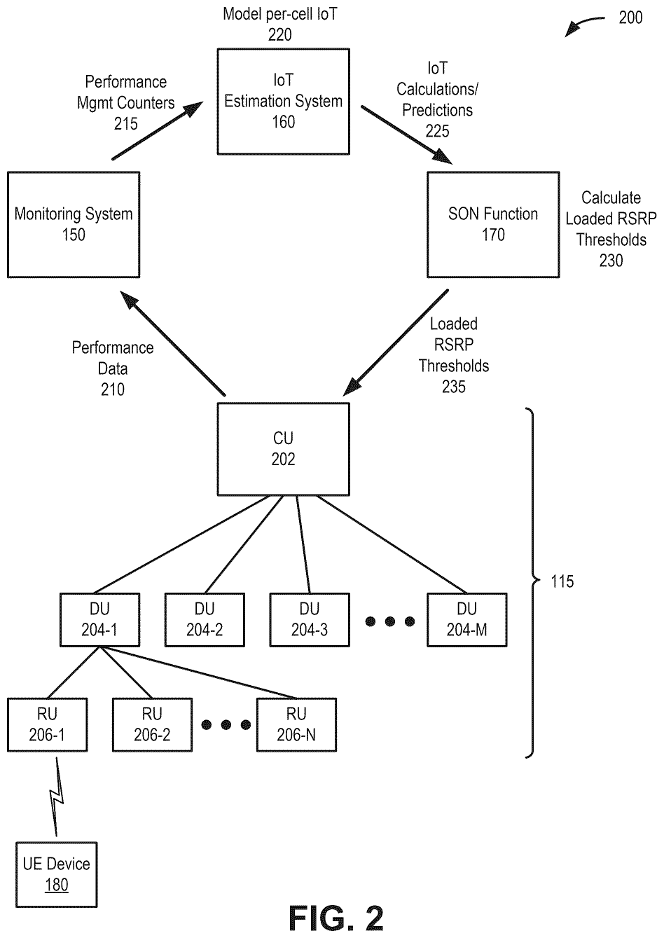

FIG. 2 illustrates communications among components in a portion 200 of network environment 100, according to an implementation. Consistent with FIG. 1B, an access station 115 is included in access network 110. Although access network 105 may include other access stations 115, they are not shown in FIG. 1B for simplicity. Each of access station 115 includes a central unit (CU) 202, distributed units (DUs) 204-1 through 204-M, and, for each DU 204, one or more Radio Units (RUs) 206-1 through 206-N. An RU 206 may also be referred to as a remote radio head (RRH). For simplicity, other RUs are not shown in FIG. 2.

CUs 202 may control DUs 204 over a front haul interface. CUs 202 may manage, for example, sharing access network 110, conveying user data, mobility, sessions, etc. For each CU 202, there may be multiple DUs 204 that the CU 202 controls. CU 202 may process upper layers of the communication protocol stack for access station 115. CUs 202 may not necessarily be physically located near DUs 204, and may be implemented as cloud computing elements, through network function virtualization (NFV) capabilities of the cloud. In one implementation, CU 202 communicates with components of core network 130 through S1/NG interfaces and with other CUs 202 (not shown) through X2/XN interfaces. According to implementations described herein, CU 202 may provide performance data 210 of individual cell/sectors to monitoring system 150. Performance data 210 may include, for example, a DL SS-RSRP value (measured at each UE device 180).

DUs 204 may be controlled by CU 202. A CU 202 may control multiple DUs 204. Each DU 204 may send signals to multiple RUs 206 for transmission. DUs 204 may handle UE device mobility, from DU to DU, from an access station 115 to another access station 115, from a cell to another cell, from a beam to another beam, etc. DUs 204 may communicate with CU 202 through an F1 interface, and may process lower layers of a communication protocol stack for access station 115.

Each RU 206 may include a radio circuit (RC) and antenna elements. The RC may receive signals from DU 206, process them, and send them to the antenna elements for transmission. The antenna elements may receive the signals from the RC and radiate the signals as a DL beam. Conversely, the antenna elements in RU 206 may receive the UL signals from UE 180 and relay them through the RC to a DU 204 and CU 206.

Access station 115 may perform inter-frequency handoffs based on RSRP values reported by UE devices 180. Thresholds (e.g., RSRP values) may be used to trigger different handover events. Thresholds for inter-frequency handover events may include thresholds to initiate measurements (e.g., on a current cell and/or target cell), terminate measurements (e.g., on a current cell and/or target cell), and initiate a hand-down (e.g., based on measurements of the current cell and target cell). For example, inter-frequency hand-down measurements may start when a DL RSRP measurement for a current source cell drops below an RSRP threshold (e.g., an Event A2-start threshold) and may stop when a DL RSRP measurement for the current source cell reaches or rises above an RSRP threshold (e.g., an Event A2-stop threshold). Furthermore, a handover may be initiated when a DL RSRP measurement for a current source cell drops below an RSRP threshold (e.g., an Event A5-1 hand-down threshold) and a DL RSRP measurement for a target cell is at or above an RSRP threshold (e.g., an Event A5-2 hand-down threshold). In another implementation, inter-frequency handover from a source cell to a target cell may also be performed using Event A3, which compares the relative RSRP difference (A dB) between the source and target cells. In contrast with an A5-based event, an A3-based event typically relies on a fixed value (4 dB, for example) for the relative difference (A dB) between a target cell RSRP and a source cell RSRP to trigger a handover.

According to implementations described herein, these RSRP thresholds for A5 and A3 events (among others) may be dynamically or periodically adjusted to provide a better correlation to a desired UL signal quality at current conditions. For example, DL RSRP thresholds for individual cells may be modified to account for their respective IoT values at different times. The modified values that account for IoT may be referred to herein as loaded threshold values and/or loaded RSRP values. Corresponding measurement thresholds (e.g., A1 and A2 thresholds) may also be adjusted based on the adjusted hand-down thresholds. As another example, a dynamically adjusted A dB threshold, which may be defined as the fixed A dB plus a target cell IoT value minus a source cell IoT value, may be used. In still another example, a fixed A dB threshold may be compared against a loaded target cell RSRP value minus a loaded source cell RSRP value.

Monitoring system 150 may receive performance data from CU 202 and other CUs (not shown). Monitoring system 150 may compile performance data and provide performance management counters 215 to IoT estimation system 160. For example, for a given cell or sector monitoring system 150 may provide average Physical Uplink Shared Channel (PUSCH) interference data in dBm at periodic intervals (e.g., 10-minute, 15-minute, 30-minute, 60-minute intervals, etc.).

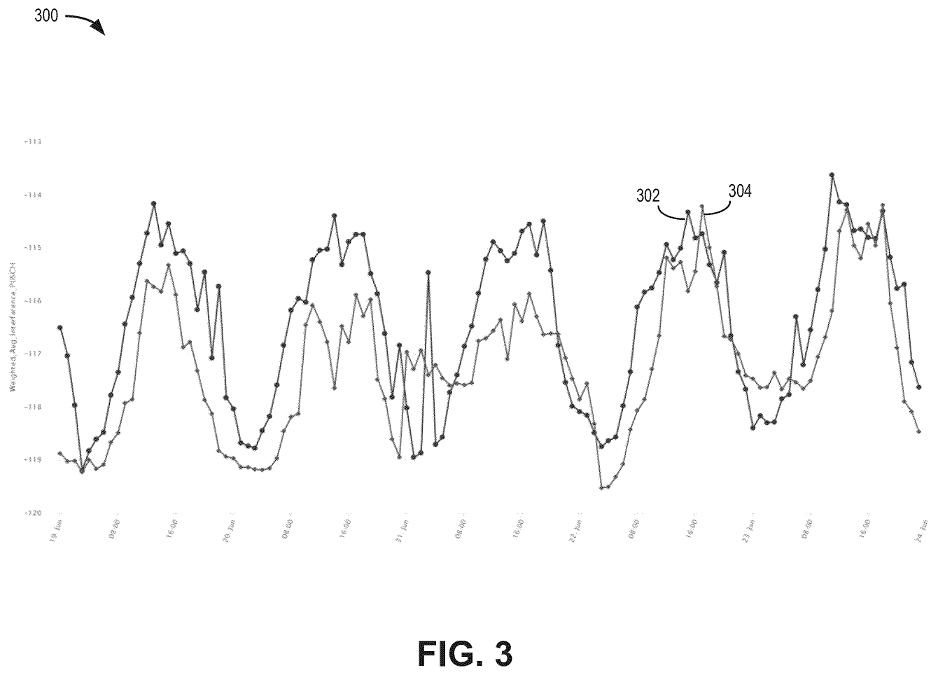

FIG. 3 is a chart 300 illustrating interference data for PUSCH signals on two different bands (“Weighted_Average_Interference_PUSCH”). Chart 300 illustrates different PUSCH interference levels that may be calculated by monitoring system 150. Monitoring system 150 may calculate the interferences per-radio bearer and per-cell for selected time intervals. While one-hour intervals are shown in FIG. 3 for simplicity, smaller or larger time intervals may be used. As illustrated in the example of FIG. 3, the PUSCH interference value may vary during a day for bands 302 and bands 304 on a cell, with interference levels ranging between about −119 dB and −114 dB. The different values for night-time, different day-to-day variation, and different patterns can be exploited to optimize threshold settings for inter-band handoffs.

Referring back to FIG. 2, IoT estimation system 160 may receive data from monitoring system 150 to estimate per-cell IoT levels. IoT estimation system 160 may model per-cell IoT 220 for individual cells based on received PUSCH interference data and other data in performance management counters 215. In one implementation, IoT may be calculated as the weighted average PUSCH interference minus a noise floor measurement, KTBF, for the cell, where K is the Boltzmann constant, T is the temperature in Kelvin, B is the bandwidth, and F is a noise factor. In another implementation, IoT may be calculated as the weighted average Physical Uplink Control Channel (PUCCH) interference minus KTBF. In still another implementation, IoT estimation system 160 may use a greater of the above PUSCH-based or PUCCH-based metrics, or a weighted average of the above PUSCH-based or PUCCH-based metrics as a measure of IoT. IoT estimation system 160 may provide IoT calculations and/or predictions 225 to SON function 170.

SON function 170 may receive IoT calculations/predictions from IoT estimation system 160 and, in turn, dynamically calculate relevant DL SS-RSRP thresholds 230 based on the computed/predicted IoT values.

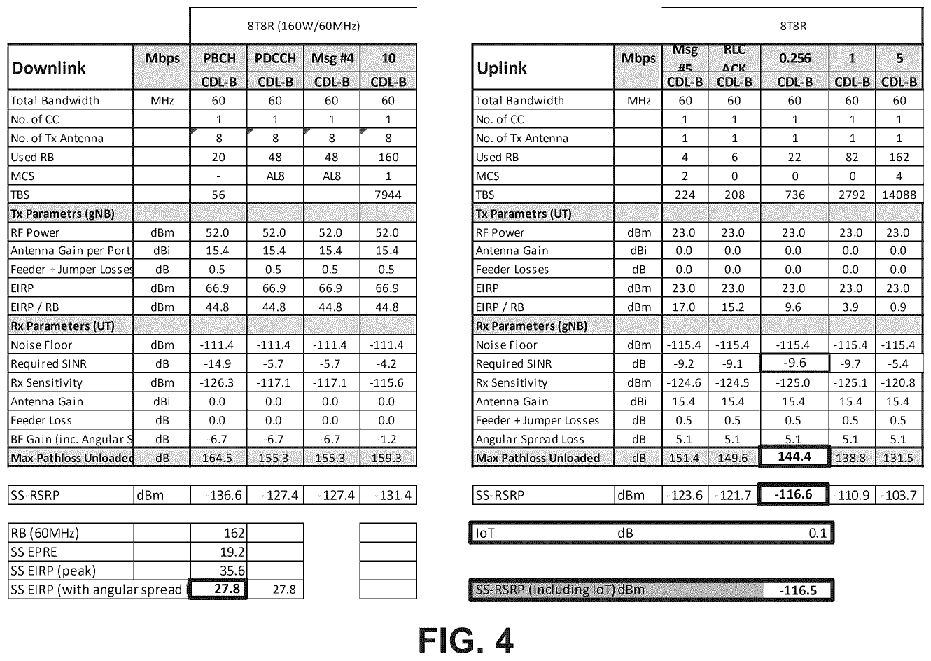

FIG. 4 illustrates values for a link budget, which is used to determine the maximum UL pathloss that can be tolerated, according to an implementation. The example shown in FIG. 4 is for a specific C-band system with a particular beamforming structure (8T8R), power level (160 Watts), and bandwidth (60 Megahertz). Under specific set of assumptions, the Maximum UL unloaded pathloss is 144.4 dB. Assuming an IoT value of 0.1 dB, the Loaded Maximum supportable Pathloss would thus be 144.3 dB.

SON function 170 may translate a UL Pathloss to a DL RSRP (also referred to as DL SS-RSRP in 5G) value for the purpose of deciding the RSRP threshold. An illustrative value of −116.6 dBm for the UE Received RSRP, shown in FIG. 4, is derived as the Transmit SS EIRP (27.8 dB) minus the Max. Pathloss Unloaded (144.4 dB). With an IoT of 0.1 dB (as provided by IoT estimation system 160), the Loaded SS-RSRP value would be −116.6 plus 0.1=−116.5 dBm. One way to interpret this number is that a required SINR of −9.6 dB (per-path) on the UL can be obtained at a DL SS-RSRP value (measured at the UE) of −116.5 dBm, provided the IoT is 0.1 dB. If, as another example, the IoT was 3 dB higher, the Loaded Max. Pathloss would be 3 dB less, and the corresponding DL SS-RSRP threshold would work out to be 3 dB higher. Thus, SON function 170 may use the following equation to determining a loaded DL RSRP threshold for a cell:

Loaded DL RSRP Threshold=Unloaded DL RSRP Threshold+IoT.

While values in FIG. 4 apply to a particular configuration for a C-band, similar calculations may be applied to 4G LTE and 5G systems in other bands.

Referring back to FIG. 2, according to an implementation, SON function 170 may calculate Loaded DL RSRP thresholds 230 for each IoT update received from IoT estimation system 160 (e.g., per-cell and per time period). In another implementation, SON function 170 may generate a loaded DL RSRP threshold schedule based on predicted IoT conditions over a range of time periods. For example, SON function 170 may generate a loaded DL RSRP threshold schedule and provide updates only when data from IoT estimation system 160 warrants changes to the schedule.

SON function 170 may forward updated RSRP thresholds 235 to CU 202 for implementation by access station 115 at the individual cell level. In one implementation, the updated RSRP thresholds 235 may be used to trigger inter-Band handoffs. In other implementations, the updated RSRP thresholds 235 may be used in combination with other indicators (e.g., RSRQ, SINR, etc.) to trigger inter-Band handoffs.

In other implementations, SON function 170 may use RSRP thresholds with IoT offsets to maximize the coverage of a UE on the UL of the C-band, as well as C-band DL in Standalone (SA) architectures. The loaded DL RSRP thresholds may also be used as a value to assure a reliable UL can be used for the target cell during inter-frequency handovers. In other implementations, loaded DL RSRP thresholds may be used to indicate when an UL is weak and trigger a handoff from a primary cell. In some implementations, loaded DL RSRP thresholds may be used to dynamically set other UL-related service levels.

Although FIG. 2 illustrates an exemplary process for implementing dynamic threshold settings for inter-Band handoffs, according to other exemplary embodiments, the process may include additional, different, and/or fewer steps. For example, additional, fewer, and/or different instances of information may be obtained or exchanged during the process. Furthermore, while one or more functions are described in conjunction with monitoring system 150, IoT estimation system 160, or SON function 170 may be combined.

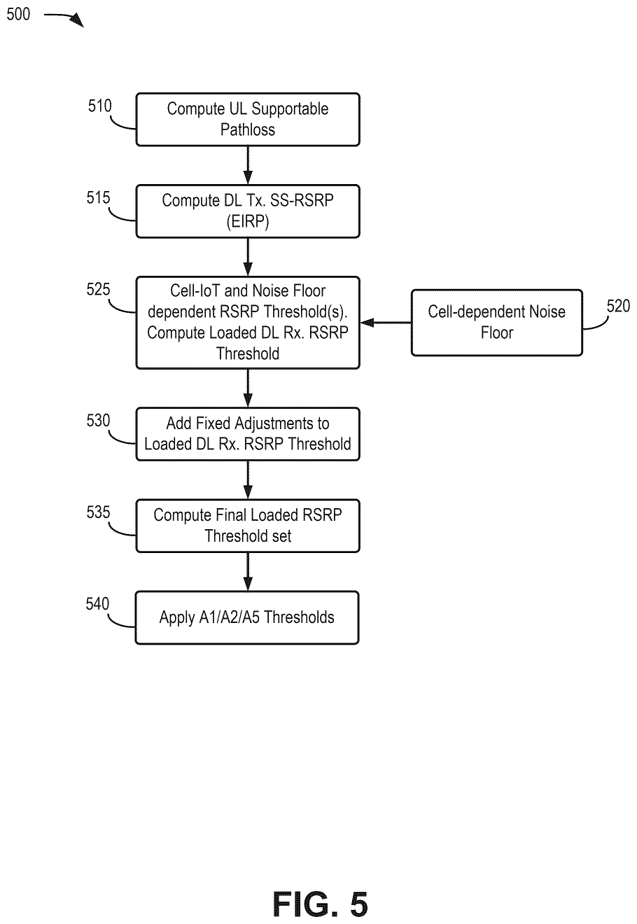

FIG. 5 is a flow diagram illustrating an exemplary process 500 for providing dynamic updates of DL RSRP handover thresholds, according to an implementation described herein. In one implementation, process 500 may be implemented by SON function 170. In another implementation, process 500 may be implemented by SON function 170 in conjunction with one or more other network elements in provider management network 120.

Process 500 may include computing a UL supportable pathloss (block 510). For example, SON function 170 may implement a link budget (e.g., FIG. 4) which will give the maximum UL pathloss that can be tolerated. The UL supportable pathloss calculation may be specific to a particular frequency band system and is dependent on the type of radio access technology (e.g., 4G, 5G, etc.), the antenna beamforming type (64T64R, 8T8R, etc.) for access station 115, and assumptions governing access network 110.

Process 500 may include determining a DL Tx SS-RSRP (block 515). For example, SON function 170 may apply link data (such as link data generated for FIG. 4 or another cell) to identify a DL Tx SS-RSRP. SON function 170 may translate the UL Pathloss to a DL Tx SS-RSRP value for the purpose of deciding the RSRP threshold. The DL Tx SS-RSRP may depend on the total power, bandwidth, cell-specific reference signal (CRS)-boost (or other adjustment), SS-Boost, Antenna Technology, etc.

Process 500 may include obtaining a cell-dependent noise floor (block 520). For example, IoT estimation system 160 or SON function 170 may obtain a noise floor for the cell. For example, a KTBF noise floor measurement described above may be used.

Process 500 may further include estimating an IoT value and computing a loaded DL Rx RSRP threshold for a cell (block 525). For example, SON function 170 may use the cell noise floor value and a weighted average interference PUSCH value to estimate an IoT value for the cell. In other implementations, SON function 170 may use a PUCCH-based IoT value or a combination of a PUSCH-based and PUCCH-based IoT value. Using the estimated IoT value, SON function 170 may calculate loaded DL Rx RSRP thresholds for the cell. The DL Rx RSRP thresholds may correspond to any of the A5-based handover event thresholds described above (e.g., A2, A5, etc.), where the loaded DL RSRP threshold may equal an unloaded DL RSRP threshold plus the IoT value. For an A3-based handover, SON function 170 may calculate a dynamically adjusted A dB threshold, where the dynamic A dB threshold equals a fixed A dB value plus a target cell IoT value minus a source cell IoT value.

Process 500 may also include adding fixed adjustments to the loaded DL RSRP threshold (block 530). For example, SON function 170 may configure threshold adjustments to ensure an optimal user experience, such as including an error factor at particular cell interfaces. For example, in one implementation, SON function 170 may apply more conservative (e.g., higher) RSRP thresholds at a cell where the UE device 180 is exiting a carrier's coverage area.

Process 500 may additionally include computing the final loaded RSRP threshold set (block 535) and applying the final RSRP thresholds as handover event thresholds (block 540). For example, SON function 170 may identify a final handoff threshold (e.g., an A5-1 threshold) that reflects an estimated interference level for the cell and may determine, based on required offsets, other hand-down threshold triggers for measurements (e.g., A1, A2, etc.). SON function 170 may provide the handover event thresholds to gNB 115 for implementation on an individual cell to maximize UL coverage on preferred bands.

While process 500 describes providing dynamic updates of DL RSRP handover thresholds for one cell, in practice, process 500 may be repeated in parallel for multiple different cells. Particularly, SON function 170 may be configured to provide dynamic updates of DL RSRP handover thresholds for any cell where the network configuration require transition from cell with a preferred band to a cell with a less-preferred band, or, vice versa, when radio conditions improve.

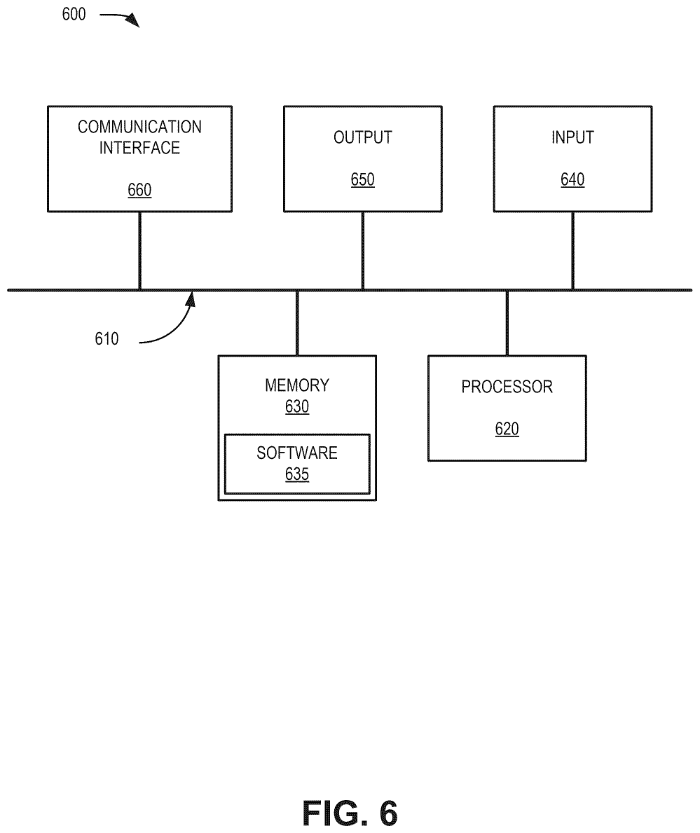

FIG. 6 is a diagram illustrating example components of a device 600 according to an implementation described herein. Access stations 115, provider devices 125, core devices 135, monitoring system 150, IoT estimation system 160, SON function 170, UE devices 180, and/or other components of network environment 100 may be implemented by one or more devices 600.

As shown in FIG. 6, device 600 may include a communication channel 610, a processor 620, a memory 630 with software 635, an input device 640, an output device 650, and a communication interface 660. Communication channel 610 may include a path or bus that permits communication among the components of device 600. Processor 620 may include a processor, a microprocessor, or processing logic that may interpret and execute instructions. Memory 630 may include any type of dynamic storage device that may store information and instructions, for execution by processor 620, and/or any type of non-volatile storage device that may store information for use by processor 620.

Software 635 includes an application or a program that provides a function and/or a process. Software 635 is also intended to include firmware, middleware, microcode, hardware description language (HDL), and/or other forms of instruction. By way of example, when device 600 is a SON system 170, software 635 may include instructions to dynamically modify RSRP thresholds, as described herein.

Input device 640 may include a mechanism that permits a user to input information to device 600, such as a keyboard, a keypad, a button, a switch, touch screen, etc. Output device 650 may include a mechanism that outputs information to the user, such as a display, a speaker, one or more light emitting diodes (LEDs), etc.

Communication interface 660 may include a transceiver that enables device 600 to communicate with other devices and/or systems via wireless communications, wired communications, or a combination of wireless and wired communications. For example, communication interface 660 may include mechanisms for communicating with another device or system via a network. Communication interface 660 may include an antenna assembly for transmission and/or reception of RF signals. For example, communication interface 660 may include one or more antennas to transmit and/or receive RF signals over the air. In one implementation, for example, communication interface 660 may communicate with a network and/or devices connected to a network. Alternatively or additionally, communication interface 660 may be a logical component that includes input and output ports, input and output systems, and/or other input and output components that facilitate the transmission of data to other devices.

Device 600 may perform certain operations in response to processor 620 executing software instructions (e.g., software 635) contained in a computer-readable medium, such as memory 630. A computer-readable medium may be defined as a non-transitory memory device. A non-transitory memory device may include memory space within a single physical memory device or spread across multiple physical memory devices. The software instructions may be read into memory 630 from another computer-readable medium or from another device. The software instructions contained in memory 630 may cause processor 620 to perform processes described herein. Alternatively, hardwired circuitry may be used in place of or in combination with software instructions to implement processes described herein. Thus, implementations described herein are not limited to any specific combination of hardware circuitry and software.

Device 600 may include fewer components, additional components, different components, and/or differently arranged components than those illustrated in FIG. 6. As an example, in some implementations, a display may not be included in device 600. As another example, device 600 may include one or more switch fabrics instead of, or in addition to, bus 610. Additionally, or alternatively, one or more components of device 600 may perform one or more tasks described as being performed by one or more other components of device 600.

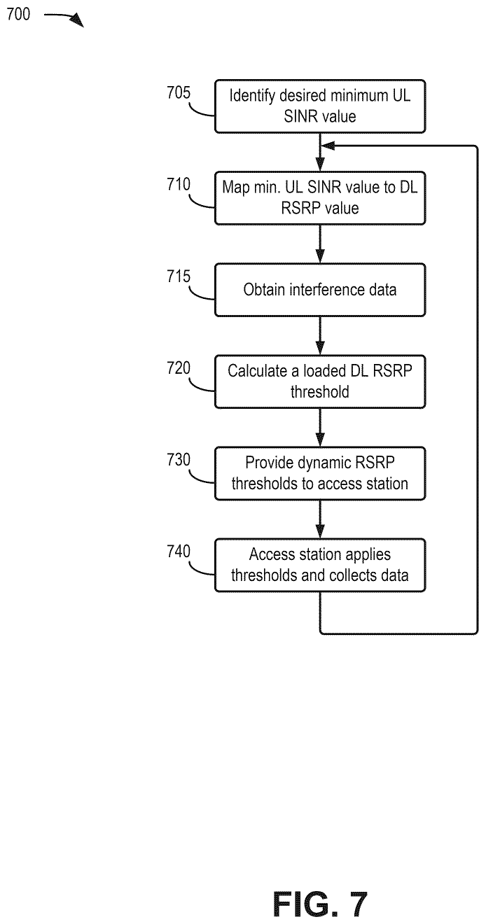

FIG. 7 is a flow diagram illustrating an exemplary process 700 for implementing dynamic updates of DL RSRP handover thresholds, according to an implementation described herein. In one implementation, process 700 may be implemented by SON function 170 and access station 115. In another implementation, process 700 may be implemented by SON function 170 and access station 115 in conjunction with one or more other network elements in provider management network 120 or access network 110.

Process 700 may include identifying a desired minimum UL SINR value (block 705) and mapping the minimum UL SINR value to a DL RSRP value (block 710). For example, SON function 170 may identify a desired minimum UL SINR value for a source cell (e.g., cell A of FIG. 1A). SON function 170 may map the minimum UL SINR value to a corresponding DL RSRP value for the source cell.

Process 700 may further include obtaining interference data for the cell (block 715). For example, SON function 170 may receive from IoT estimation system 160 an estimated interference level for a time period. In one implementation, IoT estimation system 160 may provide interference data (e.g., IoT values) for a cell to SON function 170 at about 15-minute intervals. In other implementations, smaller (e.g., about 5-minutes) or larger (e.g., about 60-minutes or more) intervals may be used.

Process 700 may also include calculating a loaded DL RSRP threshold (block 720) and providing dynamic RSRP thresholds to an access station for the source cell (block 730). For example, SON function 170 may determine, based on the DL RSRP value, a loaded DL RSRP value that reflects an estimated interference level in the cell for a set time period or a until an interference data update for the cell is provided by IoT estimation system 160. SON function 170 may provide one or more DL RSRP thresholds for implementation in the source cell based on the loaded DL RSRP value. For example, based on the loaded DL RSRP value (e.g., an A5-1 threshold), SON function 170 may determine other RSRP thresholds (e.g., A1, A2, A3, etc.).

Process 700 may also include the access station receiving/applying the dynamic RSRP thresholds and collecting service data (block 740). For example, access station 115 may apply the one or more DL RSRP thresholds, or other thresholds derived from DL RSRP thresholds, to govern a handover event for a UE device that is connected to the source cell.

Similar threshold optimizations with IoT may be performed for one or more neighboring cells or target cells to provide other handover thresholds. While implementations described herein have primarily described inter-Band handoffs based on RSRP thresholds, in other implementations, inter-Band handoffs can be triggered based on a RSRP, RSRQ, or SINR alone or in any combination. Furthermore, systems and methods described herein may apply to events A1-A5, B1, or other conditions (such as Blind re-direction). Furthermore, systems and methods described herein may also be used to provide optimized threshold settings for intra-Band handoffs.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. Thus, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of signals and blocks have been described with regard to the processes illustrated in FIGS. 2, 5, and 7, the order of the signals and blocks may be modified according to other embodiments. Further, non-dependent signals or blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 620) of a device. A non-transitory storage medium includes one or more of the storage mediums described in relation to memory 630.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method, comprising:
identifying, by a network device, a desired minimum uplink (UL) signal-to-interference-plus-noise ratio (SINR) value for a source cell;
mapping, by the network device, the minimum UL SINR value to a corresponding downlink (DL) reference signal received power (RSRP) value for the source cell;
determining, by the network device and based on the DL RSRP value, a loaded DL RSRP value that reflects an estimated interference level for a time period; and
providing, by the network device, one or more DL RSRP thresholds for implementation in the source cell based on the loaded DL RSRP value.

2. The method of claim 1, further comprising:
receiving, prior to the determining, the estimated interference level for the time period.

3. The method of claim 1, further comprising:
receiving an updated estimated interference level for the time period; and
determining an updated loaded DL RSRP value that reflects the updated estimated interference level for the time period.

4. The method of claim 1, wherein the one or more DL RSRP thresholds include a handoff threshold for the source cell.

5. The method of claim 1, wherein the one or more DL RSRP thresholds include a start measurement trigger or a stop measurement trigger for the source cell.

6. The method of claim 1, wherein the one or more DL RSRP thresholds is based on a relative difference between the loaded DL RSRP value for the source cell and another loaded DL RSRP value for a target cell.

7. The method of claim 1, wherein determining the loaded DL RSRP value includes receiving multiple predicted Interference over Thermal values for the source cell for multiple time intervals.

8. The method of claim 1, wherein the time period is less than about 60 minutes.

9. The method of claim 1, further comprising:
applying, by the access station, the one or more DL RSRP thresholds to govern a handover event for a UE device that is in the source cell.

10. The method of claim 1, wherein the network device includes one of:
a Self-Organizing Network (SON) function;
a Radio access network (RAN) Intelligent Controller (RIC); or
a Central Unit (CU).

11. A network device, comprising:
a processor configured to:
identify a desired minimum uplink (UL) signal-to-interference-plus-noise ratio (SINR) value for a source cell;
map the minimum UL SINR value to a corresponding downlink (DL) reference signal received power (RSRP) value for the source cell;
determine, based on the DL RSRP value, a loaded DL RSRP value that reflects an estimated interference level for a time period; and
provide one or more DL RSRP thresholds for implementation in the source cell based on the loaded DL RSRP value.

12. The network device of claim 11, wherein the processor is further configured to:
receive, prior to determining the loaded DL RSRP value, the estimated interference level for the time period.

13. The network device of claim 12, wherein the processor is further configured to:
receive an updated estimated interference level for the time period; and
determine an updated loaded DL RSRP value that reflects the updated estimated interference level for the time period.

14. The network device of claim 11, wherein the one or more DL RSRP thresholds include a handoff threshold for the source cell.

15. The network device of claim 11, wherein the one or more DL RSRP thresholds include a start measurement trigger and a stop measurement trigger for the source cell.

16. The network device of claim 11, wherein the processor is further configured to:
determine, for a target cell, another loaded DL RSRP value that reflects an estimated interference level for the time period.

17. The network device of claim 11, wherein, when determining the loaded DL RSRP value, the processor is further configured to:
receive multiple predicted Interference over Thermal values for the source cell for multiple time intervals.

18. A non-transitory computer-readable medium containing instructions executable by at least one processor, the computer-readable medium comprising one or more instructions for:
identifying, by a network device, a desired minimum uplink (UL) signal-to-interference-plus-noise ratio (SINR) value for a source cell;
mapping, by the network device, the minimum UL SINR value to a corresponding downlink (DL) reference signal received power (RSRP) value for the source cell;
determining, by the network device and based on the DL RSRP value, a loaded DL RSRP value that reflects an estimated interference level for a time period; and
providing, by the network device, one or more DL RSRP thresholds for implementation in the source cell based on the loaded DL RSRP value.

19. The non-transitory computer-readable medium of claim 18, further comprising one or more instructions for:
receiving an updated estimated interference level for the time period; and
determining an updated loaded DL RSRP value that reflects the updated estimated interference level for the time period.

20. The non-transitory computer-readable medium of claim 18, wherein the network device includes one of:
a Self-Organizing Network (SON) function;
a Radio access network (RAN) Intelligent Controller (RIC); or
a Central Unit (CU).
